(19) United States
(12) Patent Application Publication
(10) Pub. No.: US 2017/0180269 A1
(43) Pub. Date: Jun. 22, 2017

(54) Publisher-Subscriber Queue Provisioning

(71) Applicant: Wal-Mart Stories, Inc., Bentonville, AR (US)

(72) Inventors: Michael Lawerance Payne, Centerton, AR (US); Kevin M. Charles, Bentonville, AR (US); Richard Jackson, Bella Vista, AR (US); John Randy Frerking, Prairie Grove, AR (US)

(21) Appl. No.: 15/379,215

(22) Filed: Dec. 14, 2016

Related U.S. Application Data
(60) Provisional application No. 62/268,383, filed on Dec. 16, 2015.

(51) Int. Cl. H04L 12/927; H04L 12/26; H04L 12/875; H04L 12/879

(52) U.S. Cl. CPC H04L 47/803; H04L 49/901; H04L 43/106; H04L 47/562

(57) ABSTRACT

Methods and systems related to implementations of provisioning publisher-subscriber queues are described. The implementations include receiving, by a computing apparatus, a data queue request from a publisher. The computing apparatus may generate at least one of a publisher data queue, a publisher information queue, or an access queue. The computing apparatus may further control access to the publisher data queue based on the access queue and the publisher information queue.

### RELATED APPLICATION

This application claims the benefit of U.S. Provisional Patent Application 62/268,383 filed Dec. 16, 2015, and titled “Publisher-Subscriber Queue Provisioning”, the entire contents of which are hereby incorporated herein by reference.

### TECHNICAL FIELD

The present disclosure generally relates to methods and systems for provisioning publisher-subscriber queues.

### BACKGROUND

Publisher-subscriber is a messaging model for sharing messages. Using this model, senders of messages (i.e., publishers) may not need to program the messages to send to particular receivers (i.e., subscribers). Instead, the publishers depict published messages using classes without knowledge of the subscribers. Similarly, by subscribing to receiving messages belonging to a certain class, the subscribers receive messages in that class without knowledge of the publishers. While there are more and more uses of the publisher-subscriber model, management of this model in light of cloud-based computing is still a challenge.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a diagram depicting an example scheme in which example embodiments of the present disclosure may be implemented.

FIG. 2 is a diagram depicting another example scheme in which example embodiments of the present disclosure may be implemented.

FIG. 3 is a diagram depicting yet another example scheme in which example embodiments of the present disclosure may be implemented.

FIG. 4 is a diagram depicting still another example scheme in which example embodiments of the present disclosure may be implemented.

FIG. 5 is a block diagram depicting an embodiment of a computing apparatus in accordance with the present disclosure.

FIG. 6 is a flowchart diagram of an example process for provisioning publisher-subscriber queues in accordance with the present disclosure.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

The articles “a” and “an” are used herein to refer to one or to more than one (i.e. to at least one) of the grammatical object of the article. By way of example, “a user” means one user or more than one users. Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code or the like), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Accordingly, the terms “computer-readable medium” and “computer-readable media” herein refer to non-transitory and tangible medium and media, respectively. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or merchant interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

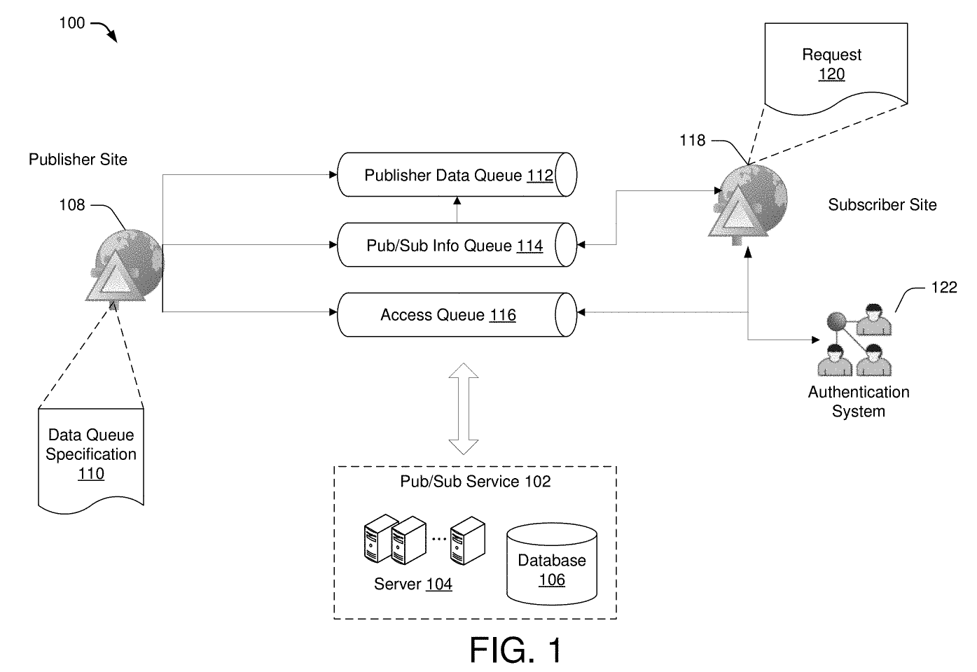

FIG. 1 is a diagram depicting an example scheme 100 in which example embodiments of the present disclosure may be implemented. Scheme 100 includes a publisher-subscriber (pub/sub) service 102 for provisioning pub/sub queues. The pub/sub service 102 may be implemented with a set of related software and/or hardware components and functionalities that provision pub/sub queues in accordance with the present disclosure. In some implementations, at least one portion of pub/sub service 102 may be implemented by a computing apparatus (e.g., a server) 104 and a database 106.

Scheme 100 further includes a publisher site 108 that facilitates a publisher to publish messages into queues. For example, publisher site 108 may transmit a data queue request to pub/sub service 102. The data queue request may include a data queue specification 110, which may include at least one of the following: a business unit associated with the publisher, a queue name, access restrictions to the queue, a format of payload (e.g., free form text) of a message of the queue, and the time to live for the message (e.g., in number of hours and/or days). In response to receiving the data queue request, pub/sub service 102 may generate a publisher data queue 112. In some embodiments, pub/sub service 102 may generate a Uniform Resource Locator (URL) for publisher data queue 112 and transmit the URL back to the publisher based on the business unit and queue name associated with the publisher.

In some embodiments, pub/sub service 102 may generate and/or update (if already generated) a pub/sub info queue 114. In some embodiments, pub/sub info queue 114 may contain queue specifications of multiple queues associated with one or more publishers. For example, an enterprise-level information queue may be generated and/or updated (if already generated) to contain multiple publisher queue specifications including multiple queues and payloads of the multiple queues. For illustration purpose without limiting the scope of the present disclosure, non-limiting examples related to queue specifications are provided in Table 1.

TABLE 1

| | | | |
|---|---|---|---|
| ~/STR_IM/COMPANY_Item | ACCESS: | DESC: | TTL: 1 |
| | RESTRICTED | ABCD | |
| ~/STR_IM/COMPANY_Store_Info | ACCESS: | DESC: | TTL: 7 |
| | RESTRICTED | ABCD | |
| ~/STR_IM/COMPANY_Item_Price | ACCESS: | DESC: | TTL: 7 |
| | PUBLIC | ABCD | |

In some embodiments, pub/sub service 102 may generate and/or update an access queue 116. In some embodiments, access queue 116 may contain restriction information of multiple queues associated with one or more publishers. For example, an enterprise-level access queue may be generated and/or updated to contain multiple publisher queues such that certain subscribers (e.g., users and applications) may have access to certain queues, as defined by the access queue, in an event that these subscribers have limited or restricted access. In some embodiments, a given queue may be generated without restriction. In some embodiments, an access to this public queue may be granted at time of receiving a subscribe request. For illustration purpose without limiting the scope of the present disclosure, non-limiting examples related to the restriction information are provided in Table 2.

TABLE 2

| | | |
|---|---|---|
| ~/STR_IM/COMPANY_Item | USER: STORESYS | ACCESS: |
| | | READ |
| ~/STR_IM/COMPANY_Item | USER: STORESYS | ACCESS: |
| | | WRITE |
| ~/STR_IM/COMPANY_Item | USER: STORESYS | ACCESS: |
| | | DELETE |
| ~/STR_IM/COMPANY_Item | USER: | ACCESS: |
| | COMPANYITEM | READ |
| ~/STR_IM/COMPANY_Item | USER: M1PAYNE | ACCESS: |
| | | READ |
| ~/STR_IM/COMPANY_Store_Info | USER: | ACCESS: |
| | COMPANYSTORE | WRITE |
| ~/STR_IM/COMPANY_Store_Info | USER: | ACCESS: |
| | COMPANYSTORE | DELETE |

Scheme 100 further includes a subscriber site 118 that facilitates one or more subscribers to subscribe messages from queues. Subscriber site 118 may transmit a subscribe request (e.g., a request 120) to access publisher data queue 112. Pub/sub service 102 may validate the subscriber against an authentication system 122 such as, for example, a Lightweight Directory Access Protocol/Resource Access Control Facility (LDAP/RACF) system.

In response to a determination that the validation is successful, pub/sub service 102 may grant access to the subscriber with respect to publisher data queue 112. The subscriber may use subscriber site 118 to search available queues and formats of these available queues after publishers create the queues. In some embodiments, in an event that publisher data queue 112 is a public queue, information of the subscriber may be inserted into access queue 116 with requested access rights.

In an event that publisher data queue 112 is restricted, the user or application may be validated by access queue 116 before access to publisher data queue 112 is granted and payload of publisher data queue is shared with the subscriber. For illustration purpose without limiting the scope of the present disclosure, non-limiting examples related to access information associated with publisher data queue 112 are provided in Table 3.

TABLE 3

| | | |
|---|---|---|
| ~/STR_IM/COMPANY_Item | USER: STORESYS | ACCESS: |
| | | DELETE |
| ~/STR_IM/COMPANY_Item | USER: STORESYS | ACCESS: |
| | | READ |
| ~/STR_IM/COMPANY_Item | USER: STORESYS | ACCESS: |
| | | WRITE |
| ~/STR_IM/COMPANY_Item | USER: | ACCESS: |
| | COMPANYITEM | READ |
| ~/STR_IM/COMPANY_Item | USER: M1PAYNE | ACCESS: |
| | | READ |
| ~/STR_IM/COMPANY_Item_Price | USER: M1PAYNE | ACCESS: |
| | | READ |

In some embodiments, pub/sub service 102 may facilitate reprocessing of data (e.g., a message of publisher data queue 112) using a last access key (i.e., the access key which was last used). In some embodiments, a Hypertext Transfer Protocol (HTTP) header may be provided to a subscriber to pull data again in an event that an issue occurs. The data may continue to be available for a predetermined period of time after an initial request has been completed.

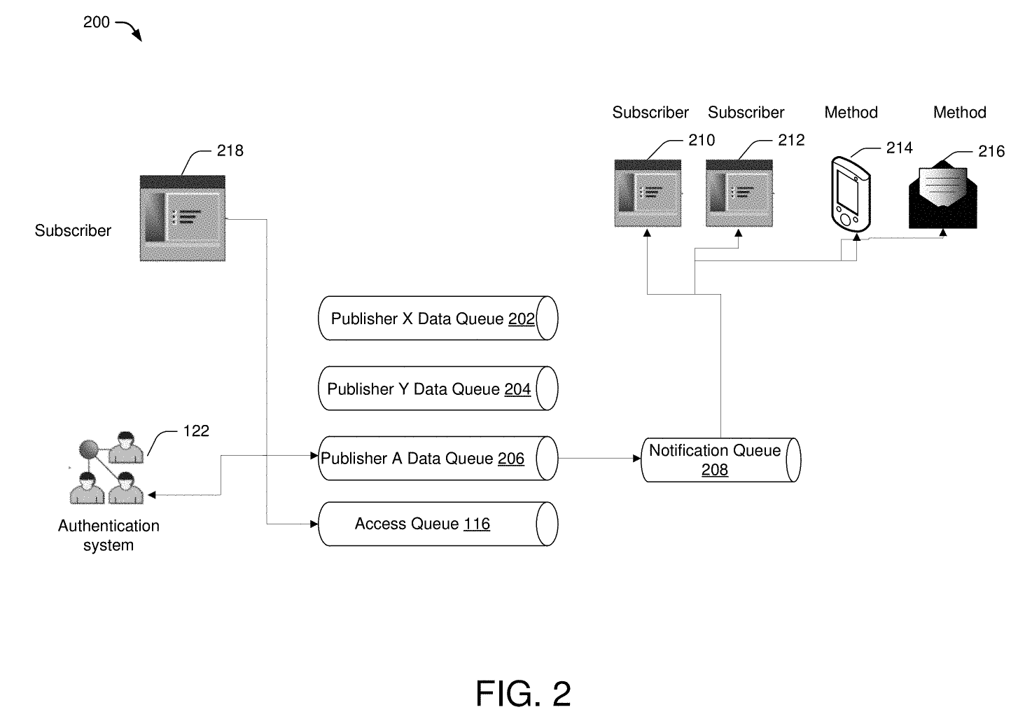

FIG. 2 is a diagram depicting another example scheme 200 in which example embodiments of the present disclosure may be implemented. Scheme 200 relates to queue message notification and may be implemented by pub/sub service 102. In response to a determination that a publisher data queue 202 (e.g., publisher X data queue 202, publisher Y data queue 204, or publisher A data queue 206) is created, pub/sub service 102 may generate and/or update (if already generated) a notification queue 208. Notification queue 208 may store multiple notification methods such as, for example, electronic mails (Email), Short Message Service (SMS), and/or Representational State Transfer (REST) services, for notifying subscribers. For example, notification queue 208 may store a method 214 and a different method, method 216, associated with a subscriber 210 and/or a subscriber 212 such that a notification of the existence/arrival of new message(s) from publisher X data queue 202, publisher Y data queue 204 or publisher A data queue 206 may be provided to subscriber 210 and/or subscriber 212 using method 214 and/or method 216. For illustration purpose without limiting the scope of the present disclosure, non-limiting examples related to queue message notification are provided in table 4.

TABLE 4

| | | |
|---|---|---|
| ~/STR_IM/COMPANY_Item | USER: | EMAIL: TEST@COMPANY.COM |
| | STORESYS | |
| ~/STR_IM/COMPANY_Item | USER: | SMS: 4795555555 |
| | STORESYS | |
| ~/STR_IM/COMPANY_Item | USER: | REST: |
| | STORESYS | http://service.company.com/data:12345 |

For example, a subscriber 218 may subscribe to messages of publisher A data queue 206. Subscriber 218 may be validated by authentication system 122. In an event that subscriber 218 is validated, subscriber 218 may have access to publisher A data queue 206. As a publisher (e.g., publisher A) publishes messages into publisher A data queue 206, information of subscriber 218 located in the HTTP header may be verified by authentication system 122. Then, using access queue 116, pub/sub service 102 may grant subscriber 218 access to publisher A data queue 206 to allow subscriber 218 to perform one or more actions on a published message of publisher A data queue 206. Further, pub/sub service 102 may generate a unique identifier (e.g., zUID) with a timestamp of the published message of publisher A data queue 206. Accordingly, the published message may contain the zUID, the timestamp, and payload of the published message.

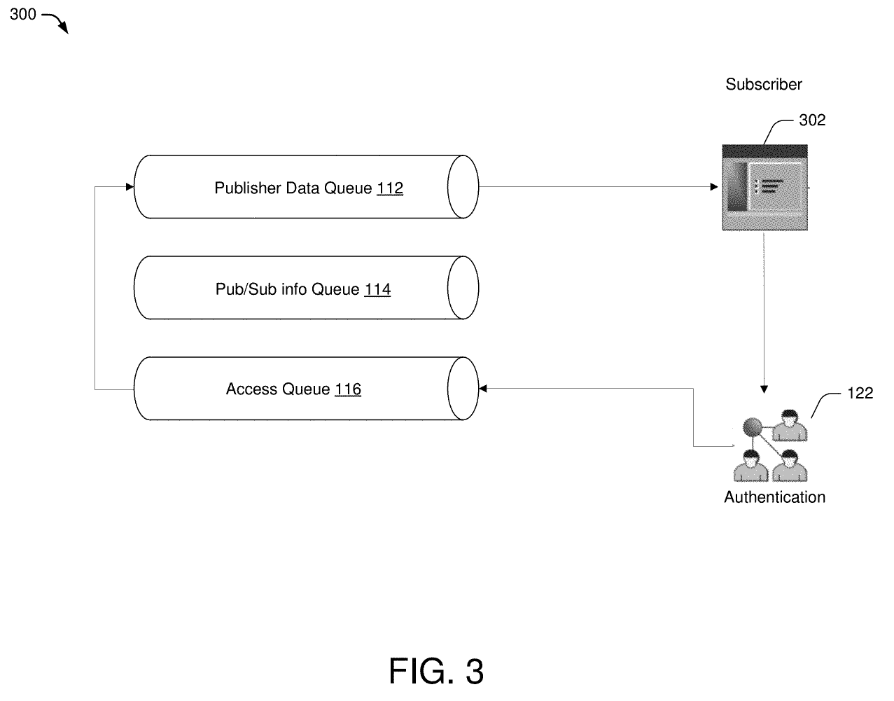

FIG. 3 is a diagram depicting yet another example scheme 300 in which example embodiments of the present disclosure may be implemented. Scheme 300 relates to a subscriber (e.g., subscriber 302) retrieving new messages from publisher data queue 112 and may be implemented by pub/sub service 102. As subscriber 302 attempts to pull new messages from publisher data queue 112, pub/sub service 102 may receive request 120 from subscriber site 118.

In some embodiments, an intermediate process may intercept request 120. In some embodiments, information of subscriber 302 located in the HTTP header may be verified by authentication system 122. For example, pub/sub service 102 may determine whether subscriber 302 is a valid LDAP/RACF user and/or whether subscriber 302 has access to the requested messages. In response to a determination that subscribe 302 is a LDAP/RACF user and/or has access to the requested messages, pub/sub service 102 may determine the last access key or a new access key to facilitate the access of publisher data queue 112. Further, pub/sub 102 may return messages that have been published using the last access key associated with subscriber 302. Pub/sub service 102 may further update access queue 116 with a new last access key (e.g., if a new access key is used for the current access) and/or update pub/sub info queue 114. Further, subscriber 302 may specify how many messages are to be received at certain time. For illustration purpose without limiting the scope of the present disclosure, non-limiting examples related to retrieving new message and uses of last access keys are provided in table 5.

TABLE 5

| | | | |
|---|---|---|---|
| ~/STR_IM/WM_Item | USER: | ACCESS: | |
| | STORESYS | DELETE | |
| ~/STR_IM/WM_Item | USER: | ACCESS: | |
| | STORESYS | READ | |
| ~/STR_IM/WM_Item | USER: | ACCESS: | |
| | STORESYS | WRITE | |
| ~/STR_IM/WM_Item | USER: | ACCESS: | LAK: 12345 |
| | WMITEM | READ | LAT: 12345 |

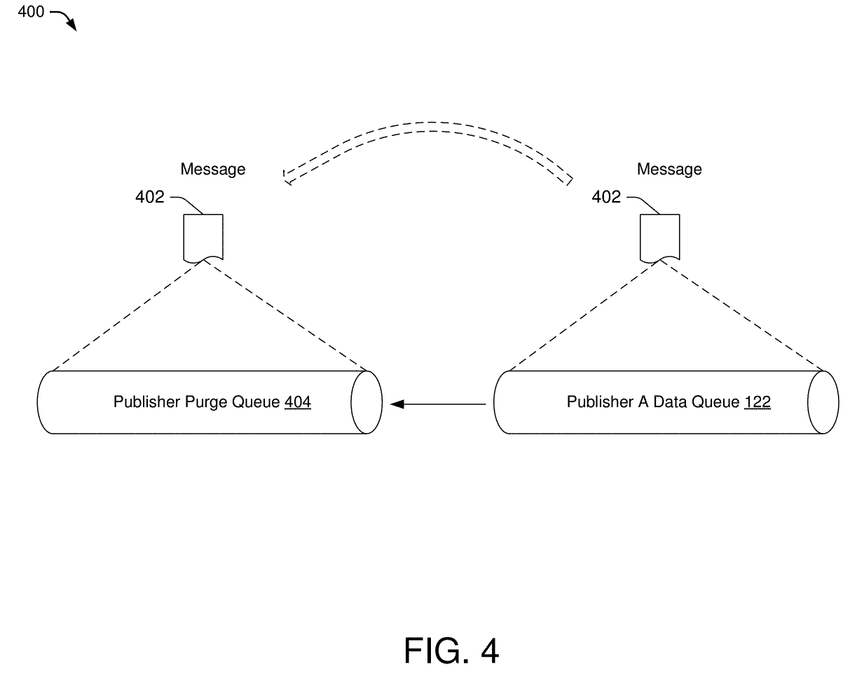

FIG. 4 is a diagram depicting still another example scheme 400 in which example embodiments of the present disclosure may be implemented. Scheme 400 relates to a publisher purge queue and may be implemented by pub/sub service 102. In the example shown in FIG. 4, as a messages 402 of publisher A data queue 122 expires, pub/sub service 102 may move message 402 into a publisher purge queue 404. In some embodiments, message 402 may be placed in publisher purge queue 404 until message 402 is removed. For example, publisher purge queue 404 may contain a URL and data of message 402 (e.g., zUID, Timestamp, payload). In some embodiments, message 402 in publisher purge queue 404 may be removed within a predetermined period of time.

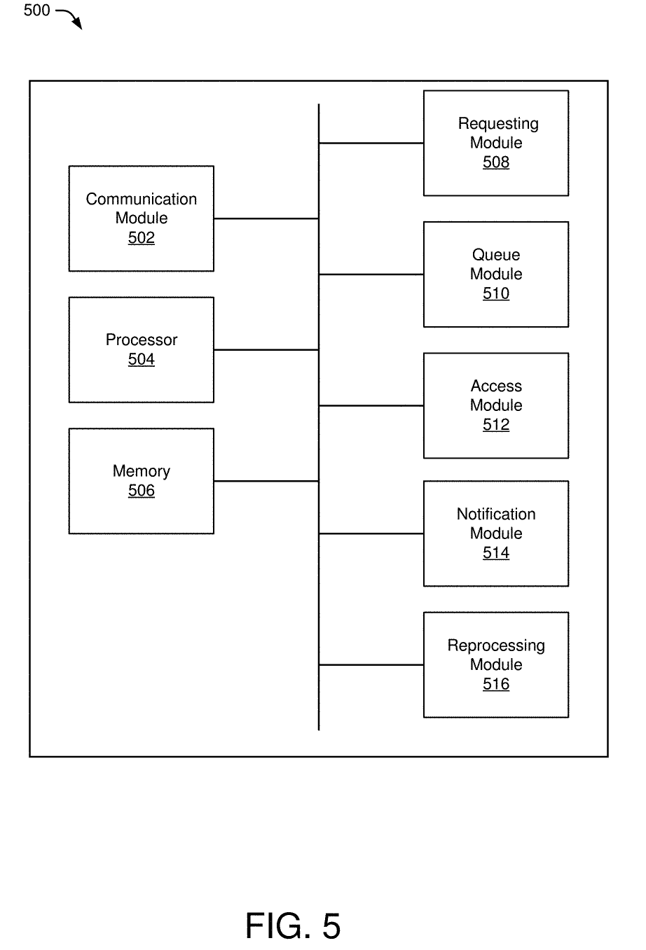

FIG. 5 is a block diagram depicting an embodiment of a computing apparatus 500 in accordance with the present disclosure. Computing apparatus 500 may perform various functions related to embodiments of the present disclosure. In some embodiments, computing apparatus 500 may be an example implementation of server 104 for pub/sub service 102 in example schemes 100, 200, 300, and 400. In some embodiments, computing apparatus 500 may be implemented as one or more processors or computing devices that cooperatively implement the functions described herein.

Computing apparatus 500 may include a communication module 502, one or more processors 504, and a memory device 506. Communication module 502 may allow computing apparatus 500 to communicate with other networks, systems, servers and/or computing devices, which may execute one or more sets of instructions to implement the functionality provided by computing apparatus 500. Memory 506 may store one or more sets of instructions executable by processor(s) 504 as well as other data used by processor(s) 504. Computing apparatus 500 may also include various modules such as a requesting module 508, a queue module 510, an access module 512, a notification module 514, and a reprocessing module 516.

Requesting module 508 may be configured to receive a data queue request from publisher site 108. For example, the data queue request may include at least one of the following: an entity name of a publisher, a name of publisher data queue 112, an access restriction of publisher data queue 112, a format of payload of publisher data queue 112, or an expiration time of a message of publisher data queue 112.

Queue module 510 may be configured to generate publisher data queue 112 based on the data queue request. Queue module 510 may further update and/or generate pub/sub info queue 114, which may include a specification of publisher data queue 112 and other specifications of multiple publisher data queues. Queue module 510 may further update and/or generate access queue 116, which may include one or more access restrictions of publisher data queue 112. In some embodiments, queue module 510 may update or generate notification queue 208 based on request 120. In some embodiments, notification queue 208 may contain one or more notification methods (e.g., method 214 and/or method 216) for a message of publisher data queue 112 with respect to one or more subscribers. In some embodiments, notification module 514 may be configured to notify subscriber 210 and subscriber 212 using notification queue 208.

Access module 512 may be configured to control access to publisher data queue 112 based on access queue 116 and pub/sub info queue 114. In some embodiments, computing apparatus 500 may receive, from a subscriber, request 120 for accessing publisher data queue 112. Access module 512 may perform validation on the subscriber based on access queue 116, and grant the subscriber the access to publisher data queue 112 in response to a determination that the validation is successful.

In some embodiments, access module 512 may further determine a type of publisher data queue 112 based on access queue 116. In response to a determination that publisher data queue 112 is a public data queue, access module 512 may insert information of the subscriber into access queue 116. In response to a determination that publisher data queue 112 is restricted, access module 512 may perform additional validation on the subscriber based on the one or more access restrictions of publisher data queue 112, and grant the subscriber the access to publisher data queue 112 in response to a determination that the additional validation is successful.

In some embodiments, reprocessing module 516 may be configured to determine whether message 402 of publisher A data queue 206 is expired. In response to a determination that message 402 is expired, reprocessing module 516 may move expired message 402 from publisher A data queue 206 into publisher purge queue 404. In some embodiments, reprocessing module 516 may further remove expired message 402 from publisher purge queue 404 after a predetermined period. In some embodiments, reprocessing module 516 may reprocess request 120 using a last key associated with the subscriber with respect to publisher data queue 112 in response to a determination that an issue of the access occurs. Using the last key, pub/sub service 102 may not need to recreate or republish messages of publish data queue 112 after these messages are created initially.

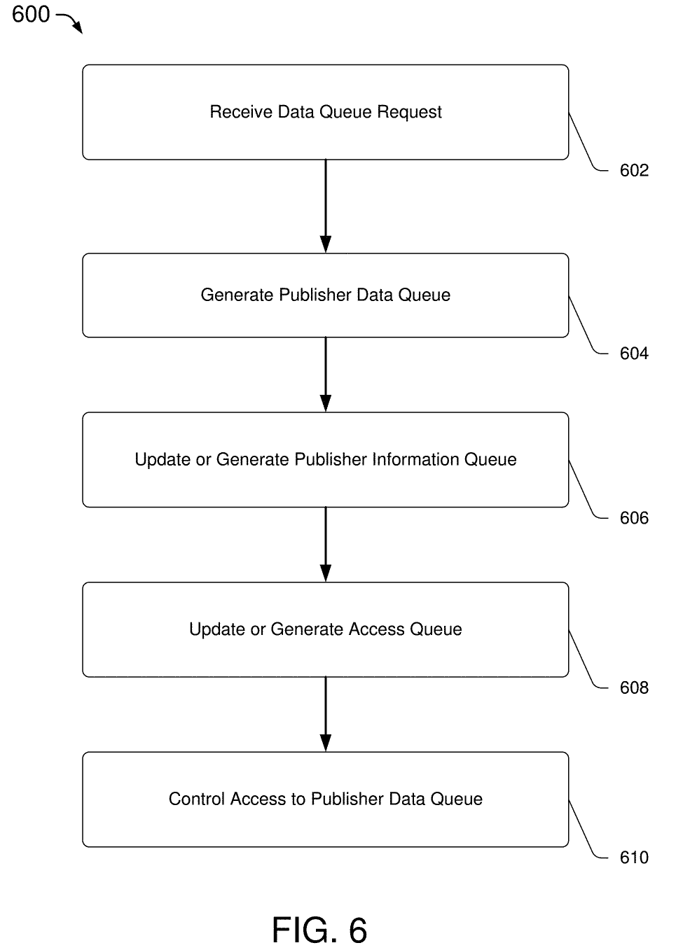

FIG. 6 is a flowchart diagram of an example process 600 for provisioning publisher-subscriber queues in accordance with the present disclosure. Process 600 may include one or more operations, actions, or functions. Although illustrated as discrete blocks, various blocks of process 600 may be divided into additional blocks, combined into fewer blocks, or eliminated, depending on the desired implementation. Process 600 may be implemented by service 102 in implementing schemes 100, 200, 300, and 400 and/or by computing apparatus 500. For illustration purpose without limiting the scope of the present disclosure, process 600 is described below in the context of being implemented by the one or more processors 504 of computing apparatus 500.

At 602, processor(s) 504 may receive a data queue request from publisher site 108 for publishing messages in publisher data queue 112. For example, the data queue request may include at least one of an entity name of the publisher, a name of publisher data queue 112, an access restriction of publisher data queue 112, a format of payload of publisher data queue 112, or an expiration time of a message of publisher data queue 112.

At 604, processor(s) 504 may generate publisher data queue 112 based on the data queue request. In some embodiments, processor(s) 504 may obtain a URL for publisher data queue 112, and then transmit the URL to the publisher based on a name of publisher data queue 112 and an entity name of the publisher.

At 606, processor(s) 504 may update and/or generate pub/sub info queue 114, which may include a specification of publisher data queue 112. For example, pub/sub info queue 114 may contain queue specifications of multiple queues associated with one or more publishers.

At 608, processor(s) 504 may update and/or generate access queue 116, which may include one or more access restrictions of publisher data queue 112. For example, processor(s) 504 may receive, from subscriber site 118, request 120 for accessing publisher data queue 112. Request 120 may include at least one of a URL of the publisher, a user ID of a subscriber, a last access key associated with publisher data queue 112 and/or the subscriber, a timestamp of request 120, or a notification method.

At 610, processor(s) 504 may control access to publisher data queue 112 based on access queue 116 and/or pub/sub info queue 114. For example, processor(s) 504 may determine a type of publisher data queue 112 based on access queue 116. In response to a determination that publisher data queue 112 is a public data queue, processor(s) 504 may insert information of the subscriber into access queue 116. In response to a determination that publisher data queue 112 is restricted, processor(s) 504 may perform additional validation on the subscriber based on the one or more access restrictions of the publisher data queue 112. Processor(s) 504 may further grant the subscriber the access to publisher data queue 112 in response to a determination that the additional validation is successful.

In some embodiments, processor(s) 504 may update and/or generate notification queue 208 based on request 120. For example, notification queue 208 may contain one or more notification methods for a message of publisher data queue 112. Processor(s) 504 may further notify the subscriber based on notification queue 208. In some embodiments, processor(s) 504 may reprocess the queue access request using a last key associated with the subscriber with respect to publisher data queue 112 in response to a determination that an issue of the access occurs.

In some implementation, processor(s) 504 may determine that message 402 of publisher data queue 112 is expired, processor(s) 504 may move expired message 402 from publisher data queue 112 into publisher purge queue 404. In some embodiments, processor(s) 504 may remove expired message 402 from publisher purge queue 404 after a predetermined period.

Although the present disclosure is described in terms of certain embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method for provisioning publisher-subscriber queues, comprising:
receiving, by a computing apparatus, a data queue request from a publisher;
generating, by the computing apparatus, a publisher data queue based on the data queue request;
updating or generating, by the computing apparatus, a publisher information queue comprising a specification of the publisher data queue;
updating or generating, by the computing apparatus, an access queue comprising one or more access restrictions of the publisher data queue; and
controlling, by the computing apparatus, access to the publisher data queue based on the access queue and the publisher information queue.

2. The method of claim 1, wherein the data queue request comprises at least one of an entity name of the publisher, a name of the publisher data queue, an access restriction of the publisher data queue, a format of payload of the publisher data queue, or an expiration time of a message of the publisher data queue.

3. The method of claim 1, further comprising:
obtaining a Uniform Resource Locator (URL) for the publisher data queue; and
transmitting the URL to the publisher based on a name of the publisher data queue and an entity name of the publisher.

4. The method of claim 1, wherein the controlling of the access to the publisher data queue based on the access queue and the publisher information queue comprises:
receiving, from a subscriber, a queue access request for accessing the publisher data queue;
performing validation on the subscriber based on the access queue; and
granting the subscriber the access to the publisher data queue in response to a determination that the validation is successful.

5. The method of claim 4, wherein the queue access request comprises at least one of a URL of the publisher, a user identifier (ID) of the subscriber, a last access key associated with the publisher data queue, a timestamp of the queue access request, or a notification method.

6. The method of claim 4, further comprising:
updating or generating a notification queue based on the queue access request, the notification queue containing one or more notification methods for a message of the publisher data queue; and
notifying the subscriber based on the notification queue.

7. The method of claim 4, further comprising:
reprocessing the queue access request using a last key associated with the subscriber with respect to the publisher data queue in response to a determination that an issue of the access occurs.

8. The method of claim 4, wherein the controlling of the access to the publisher data queue based on the access queue and the publisher information queue comprises:
determining a type of the publisher data queue based on the access queue;
in response to a determination that the publisher data queue is a public data queue, inserting the subscriber into the access queue; and
in response to a determination that the publisher data queue is restricted, performing operations comprising:
performing additional validation on the subscriber based on the one or more access restrictions of the publisher data queue; and
granting the subscriber the access to the publisher data queue in response to a determination that the additional validation is successful.

9. The method of claim 1, further comprising:
determining that a message of the publisher data queue is expired;
moving the expired message from the publisher data queue into a publisher purge queue; and
removing the expired message from the publisher purge queue after a predetermined period.

10. A system comprising:
one or more processors; and
a memory configured to store a plurality of components executable by the one or more processors, the plurality of components comprising:
a requesting module configured to receive a data queue request from a publisher;
a queue module configured to perform operations comprising:
generating a publisher data queue based on the data queue request,
updating or generating a publisher information queue comprising a specification of the publisher data queue, and
updating or generating an access queue comprising one or more access restrictions of the publisher data queue; and
an access module configured to control access to the publisher data queue based on the access queue and the publisher information queue.

11. The system of claim 10, wherein, in controlling the access to the publisher data queue based on the access queue and the publisher information queue, the access module is configured to perform operations comprising:
receiving, from a subscriber, a queue access request for the publisher data queue;
performing validation on the subscriber based on the access queue; and
granting the subscriber the access to the publisher data queue in response to a determination that the validation is successful.

12. The system of claim 11, wherein the queue access request comprises at least one of a URL of the publisher, a user ID of the subscriber, a last access key associated with the publisher data queue, a timestamp of the queue access request, or a notification method, and wherein the data queue request comprises at least one of an entity name of the publisher, a name of the publisher data queue, an access restriction of the publisher data queue, a format of payload of the publisher data queue, or an expiration time of a message of the publisher data queue.

13. The system of claim 11, wherein the queue module is further configured to update or generate a notification queue based on the queue access request, wherein the notification queue contains one or more notification methods for a message of the publisher data queue, and wherein the plurality of components further comprise a notification module configured to notify the subscriber based on the notification queue.

14. The system of claim 11, wherein the access module is further configured to reprocess the queue access request using a last key associated with the subscriber with respect to the publisher data queue in response to a determination that an issue of the access occurs.

15. The system of claim 11, wherein, in controlling the access to the publisher data queue based on the access queue and the publisher information queue, the access module is configured to perform operations comprising:
determining a type of the publisher data queue based on the access queue;
in response to a determination that the publisher data queue is a public data queue, inserting the subscriber into the access queue; and
in response to a determination that the publisher data queue is restricted, performing operations comprising:
performing additional validation on the subscriber based on the one or more access restrictions of the publisher data queue; and
granting the subscriber the access to the publisher data queue in response to a determination that the additional validation is successful.

16. The system of claim 10, wherein the plurality of components further comprise a reprocessing module configured to perform operations comprising:
determining that a message of the publisher data queue is expired;
moving the expired message from the publisher data queue into a publisher purge queue; and
removing the expired message from the publisher purge queue after a predetermined period.

17. One or more computer-readable media storing computer-executable instructions that, when executed on one or more processors, cause the one or more processors to perform acts comprising:
receiving a data queue request from a publisher;
generating a publisher data queue based on the data queue request;
generating a publisher information queue comprising a specification of the publisher data queue;
generating an access queue comprising one or more access restrictions of the publisher data queue; and
controlling access to the publisher data queue based on the access queue and the publisher information queue.

18. The one or more computer-readable media of claim 17, wherein the acts further comprise:
obtaining a URL for the publisher data queue; and
transmitting the URL to the publisher based on a name of the publisher data queue and an entity name of the publisher.

19. The one or more computer-readable media of claim 17, wherein the controlling of the access to the publisher data queue based on the access queue and the publisher information queue comprises:
receiving, from a subscriber, a queue access request for accessing the publisher data queue;
performing validation on the subscriber based on the access queue; and
granting the subscriber the access to the publisher data queue in response to a determination that the validation is successful.

20. The one or more computer-readable media of claim 19, wherein the acts further comprise:
updating or generating a notification queue based on the queue access request, the notification queue containing one or more notification methods for a message of the publisher data queue; and
notifying the subscriber based on the notification queue.
